(19) United States
(12) Patent Application Publication
(10) Pub. No.: US 2008/0030261 A1
(43) Pub. Date: Feb. 7, 2008

(54) Charge Pump Circuit

(75) Inventor: Kenichi Nakata, Kyoto (JP)

Correspondence Address: FISH & RICHARDSON P.C., P.O. BOX 1022, MINNEAPOLIS, MN, 55440-1022, US

(73) Assignee: Rohm Co., Ltd., Kyoto (JP)

(21) Appl. No.: 11/576,622

(22) PCT Filed: Oct. 17, 2005
(86) PCT No.: PCT/JP05/19010

§ 371 Date: Apr. 4, 2007

(30) Foreign Application Priority Data
Nov. 5, 2004 (JP) 2004-322865

(51) Int. Cl. G05F 1/10

(52) U.S. Cl. 327/536

(57) ABSTRACT

A charge pump circuit (1) includes first and second rectifier elements (10 and 11) connected in series between input and output terminals (7 and 9), provides a predetermined voltage from the output terminal (9) by passing charges successively through the rectifier elements (10 and 11) and accumulating the charges in an output capacitor (12), and further includes an integrator (15) integrating a difference between a feedback voltage provided from the output terminal (9) and a reference voltage, a boost capacitor (17) having an end connected to a node between the first and second rectifier elements (10 and 11), and a clock inverter (16) having power-supply-side and ground-side transistors (30 and 31) receiving a clock signal (CLK), and a variable current supply (32) supplying a current depending on the output voltage of the integrator (15) to one of the transistors, and having an output connected to the other end of the boost capacitor (17).

### TECHNICAL FIELD

The present invention relates to a charge pump circuit providing a predetermined voltage.

### BACKGROUND ART

Charge pump circuits that employ, as major components, rectifier elements such as diode elements or switch elements and capacitors have been widely used as circuits that boost an input voltage to provide a predetermined voltage. As one of such circuits, a structure performing feedback control to provide an appropriate output voltage has been proposed and disclosed, e.g., in Japanese Patent Laying-Open No. 2000-066747 (patent document 1). FIG. 5 shows a structure similar to the charge pump circuit disclosed in the patent document 1.

A charge pump circuit 101 has an input terminal 107 receiving a power supply voltage VDD, a clock input terminal 108 receiving a clock signal CLK, and an output terminal 109 providing a predetermined boosted voltage to a load connected thereto. Although not shown, the load is a power supply portion of an electric circuit achieving predetermined functions of an electric device.

First and second rectifier elements 110 and 111 that are diode elements are connected in series between input and output terminals 107 and 109. Output terminal 109 is connected to an output capacitor 112 and a series connection unit of resistances 113 and 114 dividing an output voltage. A voltage on a node between resistances 113 and 114 is provided as a feedback voltage to an operational amplifier 115. Operational amplifier 115 makes a comparison between the feedback voltage and a reference voltage V_{REF} to provide a high- or low-level signal.

The output of operational amplifier 115 is supplied to a base of NPN bipolar transistor 116 having a grounded emitter. A collector of transistor 116 is connected to a collector of an NPN bipolar transistor 117 having a grounded emitter and a base connected to its collector. The collector of transistor 117 is also connected to a constant current supply 118 passing a constant current Is from input terminal 107. The base of transistor 117 is connected to a base of an NPN bipolar transistor 119 having a grounded emitter. A collector of transistor 119 is connected to an IN terminal of a current mirror circuit 120.

An OUT1 terminal of current mirror circuit 120 is connected to a collector of an NPN bipolar transistor 121 having a grounded emitter and a collector of an NPN bipolar transistor 122 having a grounded emitter and a base connected to its collector. A base of transistor 121 is connected to clock input terminal 108.

Clock input terminal 108 is further connected to an inverter 123, which inverts and outputs clock signal CLK. Inverter 123 provides its output to a base of an NPN bipolar transistor 124 having a grounded emitter. Transistor 124 has a collector connected to an OUT2 terminal of current mirror circuit 120 as well as an emitter connected to a base of an NPN bipolar transistor 125 having a grounded emitter.

The base of transistor 122 is connected to a base of an NPN bipolar transistor 126 having a grounded emitter. A collector of transistor 126 is connected to a base of a PNP bipolar transistor 127 having an emitter connected to input terminal 107 and a collector connected to the collector of transistor 125. A node between the collectors of transistors 125 and 127 is connected to the other end of a boost capacitor 128, of which one end is connected to a node between first and second rectifier elements 110 and 111.

Charge pump circuit 101 operates as follows. When the voltage on the node between resistances 113 and 114, i.e., the feedback voltage is lower than reference voltage V_{REF}, operational amplifier 115 provides a low-level signal to turn off transistor 116. When transistor 116 is turned off, constant current Is flows through transistor 117, and further flows through transistor 119 to the IN terminal of current mirror circuit 120. Consequently, constant current Is flows through OUT1 and OUT2 terminals of current mirror circuit 120.

In this state, when clock signal CLK of clock input terminal 108 attains a high level, transistor 121 is turned on so that transistors 122 and 126 are turned off, and transistor 127 is turned off. Since transistor 124 is turned off, constant current I_{S} flows as a base current through transistor 125, and turns on transistor 125. Consequently, the voltage on the other end of boost capacitor 128 lowers, and the voltage on the negative side of first rectifier element 110 lowers. Charges move from the positive side of first rectifier element 110 to the negative side thereof, and are temporarily accumulated in boost capacitor 128.

When clock signal CLK attains a low level thereafter, transistor 121 is turned off so that constant current I_{S} flows through transistors 122 and 126, and constant current I_{S} flows as a base current through transistor 127 to turn on transistor 127. Meanwhile, transistor 124 is turned on so that transistor 125 is turned off. Consequently, the voltage on the other end of boost capacitor 128 rises, and the voltage on the negative side of first rectifier element 110, i.e., the voltage on the positive side of second rectifier element 111 rises. The charges that have been temporarily accumulated in boost capacitor 128 move from the positive side of second rectifier element 111 to the negative side thereof, and are accumulated in output capacitor 112. In this manner, the boosting operation is performed to raise the voltage of output terminal 109 when the feedback voltage is lower than reference voltage V_{REF}.

When the feedback voltage is higher than reference voltage V_{REF}, operational amplifier 115 provides a high-level signal to turn on transistor 116. When transistor 116 is turned on, transistors 117 and 119 are turned off, and a current does not flow through the IN terminal of current mirror circuit 120. Consequently, a current does not flow through the OUT1 and OUT2 terminals of current mirror circuit 120. In this state, since clock signal CLK turns off both transistors 125 and 127 regardless of the high and low levels, the charges do not move with respect to first and second rectifier elements 110 and 111. As described above, when the feedback voltage is higher than reference voltage V_{REF}, the boosting operation stops.

In a stable operation, therefore, a boosting operation takes place to raise the output voltage during a period of clock signal CLK immediately after the feedback voltage becomes lower than reference voltage V_{REF}. Thereafter, the output voltage slowly falls according to discharging of output capacitor 112 that depends on a magnitude of a load, and the boosting operation stops until the feedback voltage becomes lower than reference voltage V_{REF}. Since a period for which the boosting operation stops is present, the current consumption is suppressed as a whole. The slight rising and lowering of the output voltage, i.e., variations in output voltage described above are referred to as “ripple”, and an amplitude of the variation is referred to as a “ripple voltage”.

Patent Document 1: Japanese Patent Laying-Open No. 2000-066747

### DISCLOSURE OF THE INVENTION

### Problems to be Solved by the Invention

However, when a load is small, a discharge quantity of output capacitor 112 is extremely small so that a period or cycle of the ripple is long, and further the ripple voltage is relatively large. Consequently, a power supply portion of an electric circuit that is connected as a load swings to a relatively large extent with a long cycle so that characteristics of the electric device are liable to lower.

The invention has been made in view of the above, and an object of the invention is to provide a charge pump circuit that achieves a short cycle of ripple of an output voltage and a small ripple voltage even when a load is small.

### Means for Solving the Problems

For achieving the above object, a charge pump circuit according to the invention includes first and second rectifier elements connected in series between input and output terminals, an output capacitor connected to the output terminal, and a boost capacitor having one end connected to a node between the first and second rectifier elements; is configured such that charges are moved successively through the first and second rectifier elements by a voltage on the other end of the boost capacitor, and are accumulated in the output capacitor to attain a predetermined voltage on the output terminal; and further includes an integrator providing a voltage produced by integrating a difference between a feedback voltage fed from the output terminal and a reference voltage; and a clock inverter having transistors arranged on a power supply side and a ground side for receiving with a clock signal, and a variable current supply supplying a current depending on the output voltage of the integrator to one of the transistors on the power supply side and the ground side, and providing a voltage depending on a current supplied by the variable current supply to the other terminal of the boost capacitor.

A charge pump circuit according to another aspect of the invention includes first and second rectifier elements connected in series between input and output terminals, an output capacitor connected to the output terminal, and a boost capacitor having one end connected to a node between the first and second rectifier elements; is configured such that charges are moved successively through the first and second rectifier elements by a voltage on the other end of the boost capacitor, and are accumulated in the output capacitor to attain a predetermined voltage on the output terminal; and further includes an integrator providing a voltage produced by integrating a difference between a feedback voltage fed from the output terminal and a reference voltage, and a variable current supply arranged between the input terminal and the first rectifier element, and supplying a current depending on the output voltage of the integrator to the first rectifier element.

Preferably, the charge pump circuit further includes one or more rectifier elements connected in series between the first and second rectifier elements.

Preferably, the rectifier element is a diode element.

Preferably, the rectifier element is a switch element, and the first and second rectifier elements are alternately turned on and off.

### EFFECTS OF THE INVENTION

Since the charge pump circuit according to the invention has the integrator providing the voltage produced by integrating the difference between the feedback voltage of the output terminal and the reference voltage, and the variable current supply supplying the current depending on the output voltage of the integrator, the charge pump circuit can control the charges moving through the first and second rectifier elements so that the cycle of ripple of the output voltage can be short and the ripple voltage can be small even when a load is small.

### BRIEF DESCRIPTION OF THE DRAWINGS

FIG. 1 is a circuit diagram of a charge pump circuit according to an embodiment of the invention.

FIG. 2 is a circuit diagram of a charge pump circuit according to another embodiment of the invention.

FIG. 3 is a circuit diagram of a charge pump circuit according to still another embodiment of the invention.

FIG. 4 is a circuit diagram of a charge pump circuit according to yet another embodiment of the invention.

FIG. 5 is a circuit diagram of a charge pump circuit in the prior art.

### DESCRIPTION OF THE REFERENCE SIGNS

1-4 charge pump circuit, 7 input terminal, 8 clock input terminal, 9 output terminal, 10 and 40 first rectifier element, 11 and 41 second rectifier element, 12 output capacitor, 15 integrator, 16 clock inverter, 17 boost capacitor, 30 power-supply-side transistor forming clock inverter, 31 ground-side transistor forming clock inverter, 32 and 51 variable current supply

### BEST MODES FOR CARRYING OUT THE INVENTION

Embodiments of the invention will now be described with reference to the drawings. In the following description, the same or corresponding portions bear the same reference numbers, and description thereof is not repeated.

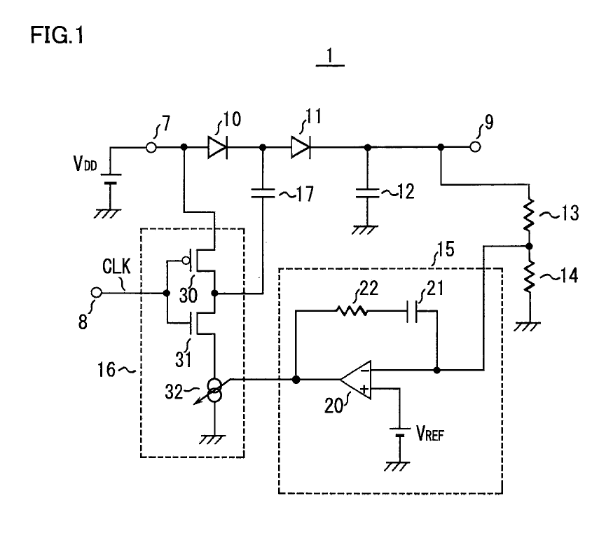

FIG. 1 is a circuit diagram of a charge pump circuit of an embodiment of the invention.

Referring to FIG. 1, a charge pump circuit 1 includes an input terminal 7 receiving a power supply voltage VDD, an input terminal 8 receiving a clock signal CLK, and an output terminal 9 providing a predetermined boosted voltage to a load connected thereto.

First and second rectifier elements 10 and 11 that are diode elements are connected in series between input and output terminals 7 and 9. Although these diode elements shown in FIG. 1 are PN junction diodes, respectively, MOS transistors each having a gate and a drain connected together or the like may be employed. Output terminal 9 is connected to an output capacitor 12 and a series connection unit of resistances 13 and 14 dividing the output voltage. Output capacitor 12 has a large capacitance for suppressing a ripple voltage as far as possible. Resistances 13 and 14 have high resistance values for reducing a current flowing toward a ground potential. A voltage on a node between resistances 13 and 14 is fed as a feedback voltage to an integrator 15.

Integrator 15 produces an output voltage by integrating a difference between the feedback voltage and reference voltage V_{REF}, and this output voltage controls a current value of a variable current supply 32 (to be described later) of a clock inverter 16. Clock inverter 16 inverts clock signal CLK provided from clock input terminal 8, and provides a voltage of a waveform depending on the current value of variable current supply 32. The output of clock inverter 16 is connected to the other end of a boost capacitor 17 for a boosting operation, and one end of boost capacitor 17 is connected to a node between first and second rectifier elements 10 and 11.

Internal circuits of integrator 15 and clock inverter 16 will now be described. Integrator 15 has an operational amplifier 20, a capacitor 21 and a resistance 22, and a node between resistances 13 and 14 is connected between an inversion input terminal of operational amplifier 20 and one end of capacitor 21. Operational amplifier 20 receives reference voltage V_{REF} on its non-inversion input terminal, receives the foregoing feedback voltage on its inversion input terminal and provides a voltage by integrating a difference between the feedback voltage provided from the output terminal and reference voltage V_{REF}. The output terminal of operational amplifier 20 forms the output of integrator 15. The other end of capacitor 21 is connected to one end of resistance 22, and the other end of resistance 22 is connected to the output terminal of operational amplifier 20. The capacitance of capacitor 21 can be relatively small. Therefore, in the case where many components of charge pump circuit 1 are integrated in an integrated circuit, integrator 15 can also be integrated therein.

Clock inverter 16 has a transistor 30 on the power supply side that is a PMOS transistor, a transistor 31 on a ground side that is an NMOS transistor and a variable current supply 32. Gates of power-supply-side transistor 30 and ground-side transistor 31 are connected to clock input terminal 8, a source of power-supply-side transistor 30 is connected to input terminal 7, and a source of ground-side transistor 31 is connected to variable current supply 32. A drain of power-supply-side transistor 30 is connected to a drain of ground-side transistor 31, and a node between these drains forms an output of clock inverter 16. Variable current supply 32 supplies a current toward the ground potential, and the current value thereof is controlled by the output voltage of integrator 15 as already described. Variable current supply 32 may be arranged between input terminal 7 and power-supply-side transistor 30.

An operation of charge pump circuit 1 will now be described. Charges supplied from power supply voltage V_{DD} via input terminal 7 are moved successively through first and second rectifier elements 10 and 11 by the voltage on the other end of boost capacitor 17, and are accumulated by output capacitor 12. Thereby, output terminal 9 provides a predetermined voltage.

The charges successively move through first and second rectifier elements 10 and 11 as described below in greater detail. When clock signal CLK of clock input terminal 8 is high, the output voltage of clock inverter 16 lowers, and causes the voltage on the negative side of first rectifier element 10 through boost capacitor 17 to lower. Therefore, the charges move from the positive side of first rectifier element 10 to the negative side, and are temporarily accumulated in boost capacitor 17. When clock signal CLK becomes low thereafter, the output of clock inverter 16 rises, and the voltage on the negative side of first rectifier element 10, i.e., the voltage on the positive side of second rectifier element 11 rises. The charges temporarily accumulated in boost capacitor 17 move from the positive side of second rectifier element 11 to the negative side, and are accumulated in output capacitor 12.

Resistances 13 and 14 divide the output voltage on output terminal 9, and integrator 15 integrates the feedback voltage, i.e., the voltage on the node between them. The output voltage (integrated voltage) of integrator 15 controls the current value of variable current supply 32 to increase it with rising of the output voltage of integrator 15, and to decrease it with lowering of the output voltage. This current value controls the degree of lowering of the output voltage of clock inverter 16, and consequently determines the charges that move through first and second rectifier elements 10 and 11.

More specifically, when the load coupled to output terminal 9 increases, the integrated voltage provided from integrator 15 slightly rises, and the current value of variable current supply 32 increases. When the output voltage of clock inverter 16 lowers while the current value of variable current supply 32 is large, this lowering of the output voltage occurs to a large extent, and the charges moving from the positive side of first rectifier element 10 to the negative side increase in quantity. Conversely, when the load coupled to output terminal 9 is small, the integrated voltage provided from integrator 15 slightly lowers, and the current value of variable current supply 32 decreases. When the output voltage of clock inverter 16 lowers while the current value of variable current supply 32 is small, this lowering of the output voltage occurs to a small extent, and the charges moving from the positive side of first rectifier element 10 to the negative side decrease in quantity. The charges moving through first rectifier element 10 move through second rectifier element 11, and are accumulated in output capacitor 12 as already described.

Accordingly, the charges moving through the first and second rectifier elements are controlled according to the load. When the load is small, the moving charges decrease so that the ripple voltage lowers. When the ripple voltage is low, the period of ripple is short even when the discharge quantity of output capacitor 12 is very small. Although there is no period during which the boosting operation stops, current consumption is suppressed because wasteful charges do not move through first and second rectifier elements 10 and 11.

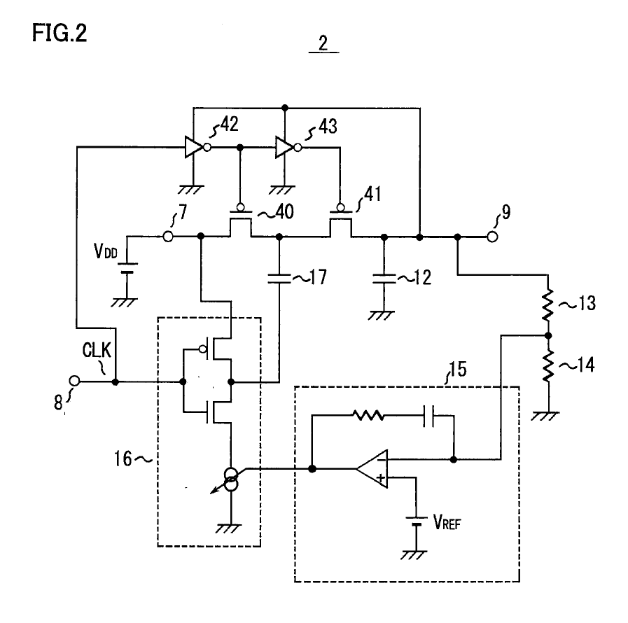

Referring to FIG. 2, description will now be given on an embodiment using switch elements as the first and second rectifier elements of the charge pump circuit.

Referring to FIG. 2, a charge pump circuit 2 has input terminal 7, clock input terminal 8 and output terminal 9 similarly to charge pump circuit 1, and also has a series connection unit of output capacitor 12 and resistances 13 and 14 dividing the output voltage, integrator 15, clock inverter 16 and boost capacitor 17. First and second rectifier elements 40 and 41 that are PMOS transistors and serve as switch elements, respectively, are connected in series between input and output terminals 7 and 9. A gate of first rectifier element 40 is connected to an output of inverter 42 inverting clock signal CLK, and a gate of second rectifier element 41 is connected to an output of an inverter 43 further inverting the output of inverter 42. Inverters 42 and 43 are supplied with the output voltage on output terminal 9 as a power supply.

Charge pump circuit 2 operates similarly to charge pump circuit 1 as a whole, but first and second rectifier elements 40 and 41 are alternately turned on and off in synchronization with the changes in voltage on the negative side of first rectifier element 40 through boost capacitor 17. More specifically, when clock signal CLK on clock input terminal 8 is high, the voltage on the negative side of first rectifier element 40 lowers through boost capacitor 17, and first rectifier element 40 is turned on so that boost capacitor 17 temporarily accumulates the charges. When clock signal CLK becomes low thereafter, the voltage on the negative side of first rectifier element 40, i.e., the voltage on the positive side of second rectifier element 41 rises, and second rectifier element 41 is turned on so that output capacitor 12 accumulates the charges that have been temporarily accumulated in boost capacitor 17.

Although FIG. 2 shows the PMOS transistor as the switch element, an NMOS transistor or the like may be used. The signals controlling the gates of first and second rectifier elements 40 and 41 may employ a period of non-overlapping. In this case, it is necessary to change output polarities of inverters 42 and 43, and to add a delay element, but the manners of such change and addition are well know to those skilled in the art, and therefore are not described herein.

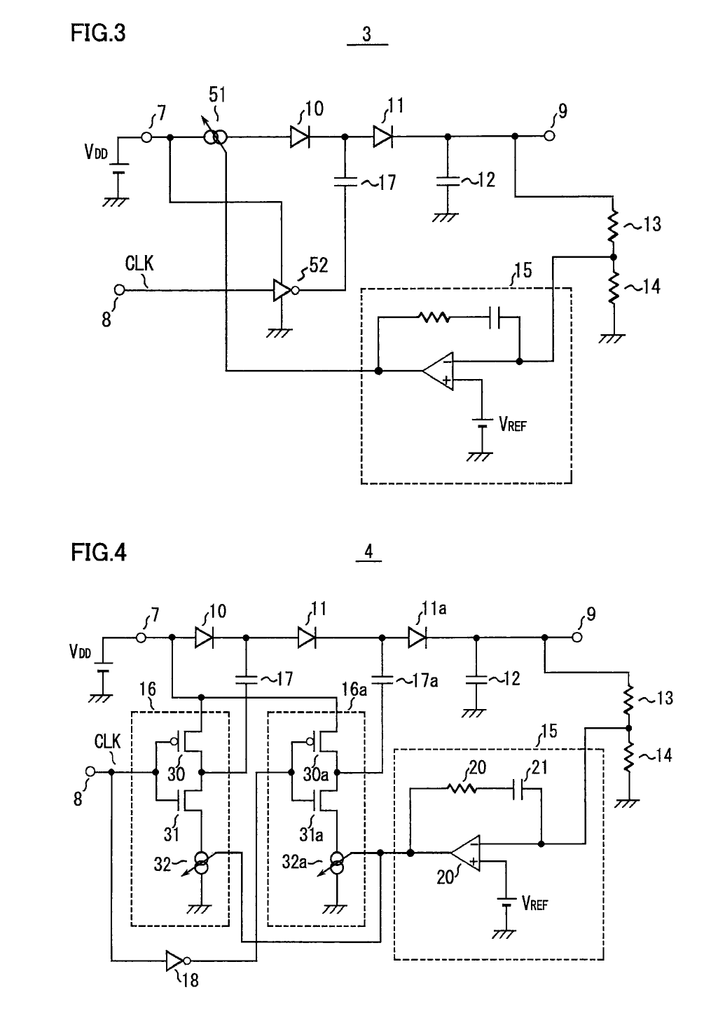

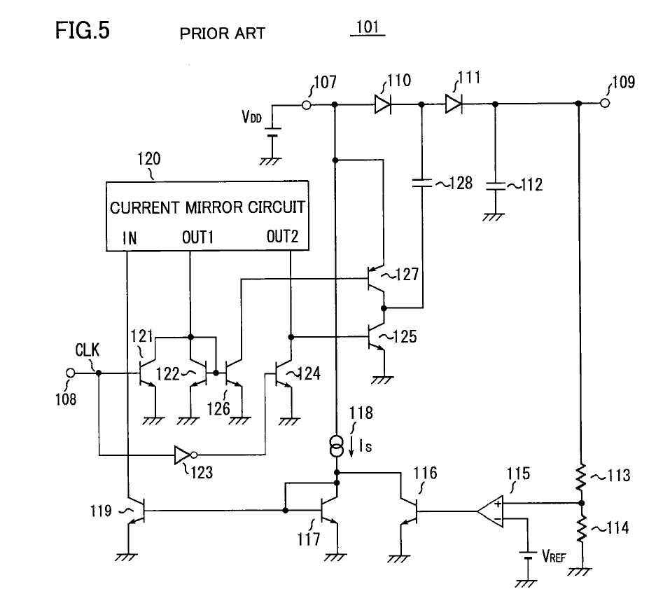

Referring to FIG. 3, description will now be given on still another embodiment in which the variable current supply is arranged in series with the first and second rectifier elements.

Referring to FIG. 3, a charge pump circuit 3 has input terminal 7, clock input terminal 8 and output terminal 9 similarly to charge pump circuit 1, and also has the series connection unit of output capacitor 12 and resistances 13 and 14 dividing the output voltage, integrator 15 and boost capacitor 17. First and second rectifier elements 10 and 11 that are diode elements are connected in series between input and output terminals 7 and 9. Further, a variable current supply 51 is arranged between input terminal 7 and first rectifier element 10, and is controlled by the output voltage of integrator 15. The other end of boost capacitor 17 is connected to an output of a clock inverter 52. Clock inverter 52 inverts clock signal CLK provided from clock input terminal 8, but does not have a variable current supply.

Charge pump circuit 3 operates similarly to charge pump circuit 1 as a whole, but the current value of variable current supply 51 is controlled by the integrated voltage provided from integrator 15. This current value is the quantity of charges that can move per unit time, and therefore determines the charges that move through first and second rectifier elements 10 and 11. When the load is small, the ripple voltage is small, and the ripple period is short similarly to charge pump circuit 1. Also, the current consumption is suppressed.

Although charge pump circuit 3 is a modification of charge pump circuit 1, charge pump circuit 2 may be modified, and such a configuration may be employed that the switch elements are used as the first and second rectifier elements, and are arranged in series with the variable current supply.

Referring to FIG. 4, description will now be given on an embodiment in which the first and second rectifier elements as well as a further rectifier element(s) are connected in series between input and output terminals 7 and 9 for further boosting the output voltage.

Referring to FIG. 4, a charge pump circuit 4 includes, in addition to the components of charge pump circuit 1, a third rectifier element 11 a arranged between second rectifier element 11 and output terminal 9, and a second boost capacitor 17a having an end connected to a node between second and third rectifier elements 11 and 11a. The other end of second boost capacitor 17a is connected to an output of a second clock inverter 16a having the same structure as clock inverter 16. Gates of second power-supply-side transistor 30a and a second ground-side transistor 31a of second clock inverter 16a are connected to an output of an inverter 18 that inverts clock signal CLK. A current value of a second variable current supply 32a is controlled by the output voltage of integrator 15 similarly to variable current supply 32.

Charge pump circuit 4 operates as follows. When clock signal CLK is high, the voltage on the negative side of first rectifier element 10 lowers, and the voltage on the negative side of second rectifier element 11 rises. Therefore, the charges move from the positive side to the negative side of first rectifier element 10, and are temporarily accumulated in boost capacitor 17. Also, the charges temporarily accumulated in second boost capacitor 17a move from the positive side to the negative side of third rectifier element 11a, and are accumulated in output capacitor 12. When clock signal CLK becomes low thereafter, the voltage on the negative side of first rectifier element 10 rises, and the voltage on the negative side of second rectifier element 11 lowers. Accordingly, the charges temporarily accumulated in boost capacitor 17 move from the positive side to the negative side of second rectifier element 11, and are temporarily accumulated in second boost capacitor 17a.

In some cases, one of two clock inverters 16 and 16a may be configured not to have a variable current supply. This is because it is merely required to control only the charges moving through only one of the rectifier elements in some cases. Naturally, one or more rectifier element(s) may be employed in addition to third rectifier element 11a. Charge pump circuits 2 and 3 may be modified similarly to charge pump circuit 1.

Although the charge pump circuits of the embodiments of the invention have been described, the invention is not restricted to the descriptions of the embodiments, and various changes in design may be performed within a scope of the appended claims. For example, integrator 15 may be formed of another internal circuit. In the embodiments already described, the output voltage takes a positive value. However, the invention can be applied to the structure in which the output voltage takes a negative value. Naturally, the MOS transistor may be replaced with a bipolar transistor.

Although the present invention has been described and illustrated in detail, it is clearly understood that the same is by way of illustration and example only and is not to be taken by way of limitation, the spirit and scope of the present invention being limited only by the terms of the appended claims.

1. A charge pump circuit comprising first and second rectifier elements connected in series between input and output terminals, an output capacitor connected to the output terminal, and a boost capacitor having one end connected to a node between said first and second rectifier elements; being configured such that charges are moved successively through said first and second rectifier elements by a voltage on the other end of said boost capacitor, and are accumulated in said output capacitor to attain a predetermined voltage on said output terminal; and further comprising:
an integrator providing a voltage produced by integrating a difference between a feedback voltage fed from said output terminal and a reference voltage; and
a clock inverter having transistors arranged on a power supply side and a ground side for receiving a clock signal, and a variable current supply supplying a current depending on the output voltage of said integrator to one of said transistors on the power supply side and the ground side, and providing a voltage depending on a current supplied by said variable current supply to the other terminal of said boost capacitor.

2. A charge pump circuit comprising first and second rectifier elements connected in series between input and output terminals, an output capacitor connected to the output terminal, and a boost capacitor having one end connected to a node between said first and second rectifier elements; being configured such that charges are moved successively through said first and second rectifier elements by a voltage on the other end of said boost capacitor, and are accumulated in said output capacitor to attain a predetermined voltage on said output terminal; and further comprising:
an integrator providing a voltage produced by integrating a difference between a feedback voltage fed from said output terminal and a reference voltage; and
a variable current supply arranged between said input terminal and said first rectifier element, and supplying a current depending on the output voltage of said integrator to said first rectifier element.

3. The charge pump circuit according to claim 1, further comprising:
one or more rectifier elements connected in series between said first and second rectifier elements.

4. The charge pump circuit according to claim 1, wherein said rectifier element is a diode element.

5. The charge pump circuit according to claim 1, wherein
said rectifier element is a switch element, and the first and second rectifier elements are alternately turned on and off.

6. The charge pump circuit according to claim 2, further comprising:
one or more rectifier elements connected in series between said first and second rectifier elements.

7. The charge pump circuit according to claim 2, wherein said rectifier element is a diode element.

8. The charge pump circuit according to claim 2, wherein
said rectifier element is a switch element, and the first and second rectifier elements are alternately turned on and off.
